(19) United States
(12) Patent Application Publication
(10) Pub. No.: US 2006/0126593 A1
(43) Pub. Date: Jun. 15, 2006

(54) Content reception/reproduction device and content reception/reproduction method

(75) Inventors: Masahiro Nagata, Shizuoka (JP); Suguru Yoshioka, Shizuoka (JP)

Correspondence Address: HARNESS, DICKEY & PIERCE, P.L.C., P.O. BOX 828, BLOOMFIELD HILLS, MI, 48303, US

(73) Assignee: NIHON COMPUTER CO., LTD., Hamamatsu-shi, Shizuoka-ken (JP)

(21) Appl. No.: 10/533,871

(22) PCT Filed: Oct. 31, 2003
(86) PCT No.: PCT/JP03/13987

§ 371 Date: Nov. 10, 2005

(30) Foreign Application Priority Data
Nov. 6, 2002 (JP) 2002-322107

(51) Int. Cl. H04L 12/66

(52) U.S. Cl. 370/352

(57) ABSTRACT

A content reception and reproduction apparatus and content reception and reproduction method capable of avoiding the discontinuity of content reproduction and preventing the user from experiencing an unpleasant feeling, such as irritation or anxiety, so that the user can pleasantly enjoy the content, has an auxiliary content acquiring mechanism to acquire a reproducible content other than a main content, as an auxiliary content. A content switching mechanism switches a content for reproduction by a reproduction mechanism to any one of the main content and the auxiliary content. The main content for reproduction is switched to the auxiliary content when the amount of accumulation of the main contents falls short of a predetermined reference amount during a reproduction of the main contents. The content for reproduction is returned to the main content when the amount of accumulation exceeds the reference amount.

### CROSS-REFERENCE TO RELATED APPLICATION

This application claims priority to Japanese Patent Application No. 2002-322107, filed Nov. 6, 2002 and PCT/JP2003/013987 filed Oct. 31, 2003, which applications are herein expressly incorporated by reference.

### FIELD OF THE INVENTION

The present invention relates to a content reception and reproduction apparatus and a content reception and reproduction method for receiving a variety of contents through a communication device to reproduce them.

### BACKGROUND OF THE INVENTION

An example of a prior art content reception and reproduction apparatus is Japanese laid open patent publication No. 200881/1998. This publication discloses a digital service reception terminal unit. The digital service reception terminal unit provides a utilizing unit of digital contents that does not give the user an unpleasant feeling due to a low transmission reaction speed even in an unstable transmission speed state. In the digital service reception terminal unit, in order to prevent the user from experiencing an unpleasant feeling even when the transmission speed is unstable and the transmission reaction speed is decreased, a specified monitoring device monitors a congestion level of communication in the network. Thus, the content in transmission is switched to local data, which is arranged in advance for reproduction, when the congestion level deteriorates in the network. This prevents the user from experiencing an unpleasant feeling without delay of the display output.

In the prior art digital service reception terminal unit, however, it is always necessary to provide a device to monitor the congestion level in the network. In this congestion level monitoring means, the current congestion level must be considered with reference to a record of the past congestion levels, and moreover, the most important information must be estimated by predicting a congestion level in the near future on the basis of the past records. However, since the congestion level of communication in the network is determined according to the state of utilization of a large number of users that is changing minute by minute, and has no direct relationship with congestion levels immediately before the present, it is extremely difficult to predict congestion levels in the near future. Thus, extremely complicated processes of monitoring and predicting are required to precisely monitor congestion levels.

Also, when time information for reproduction of data is included in a received content data, even if a congestion level of communication is under a favorable state in the network and it is possible to receive data without delay, a reproduction time period does not coincide with an actual reproduction time period. The received contents are reproduced according to a reception data speed, which comes to an unnatural reproduction. Accordingly, when the data having time control information for reproduction is received as a content to coincidently reproduce them, the prediction of a congestion level of communication is impossible due to the variation of congestion levels in the network. Thus, it is technically difficult to display an output that does not give the user irritation and/or anxiety.

Even if a congestion state can be exactly grasped, an operation in which received data through the network is switched to local data every time congestion is detected can give the user an unpleasant feeling, such as irritation and/or anxiety, due to the frequent change of the display under the conditions where a congestion state frequently occurs.

In view of the foregoing circumstances, it is an object of the present invention to provide a content reception and reproduction apparatus and a content reception and reproduction method which avoids the discontinuity of content reproduction. This prevents the user from experiencing an unpleasant feeling, such as irritation and/or anxiety, and gives the user a pleasant enjoyment of contents.

### SUMMARY OF THE INVENTION

A content reception and reproduction apparatus comprises an auxiliary content acquiring mechanism for acquiring a reproducible content other than a main content as an auxiliary content. A content switching mechanism for switching a content for reproduction by a reproduction mechanism to any one of the main content and the auxiliary content where a content for reproduction is switched to the auxiliary content when the amount of accumulation of the main contents falls short of a predetermined reference amount during a reproduction of the main contents. A content for reproduction is returned to the main content when the amount of accumulation exceeds the reference amount.

A content reception and reproduction method comprises starting a reproduction of a main content after a state where a reproducible content other than the main content can be acquired as an auxiliary content. Switching a content for reproduction to the auxiliary content when the amount of accumulation of the main contents falls short of a predetermined reference amount during a reproduction of the main contents. Returning a content for reproduction to the main content when the amount of accumulation exceeds the reference amount.

The term “content” relates to a time correlation continual data having a time element (time factor), such as picture and/or voice (including music). Also, a still picture is included in content by means of sequentially displaying one and/or a plurality of still pictures to provide the still picture with time correlation.

The term “main content” is defined by a content such as a movie and/or a audiovisual program that the user of the content reception and reproduction apparatus has received through communication lines for enjoyment. The term “auxiliary content” is defined by a stably reproducible content other than the main content, such as a commercial message, weather information, traffic information, landscape and background music, serving as an auxiliary role for the main content.

The term “reproduction” is defined by a display of accumulated contents including a real time display of received contents without accumulating them.

A content for reproduction is switched to an auxiliary content regardless of congestion of communication when the amount of accumulation of the main contents falls short of a predetermined reference amount during a reproduction of the main contents. A content for reproduction is returned to the main content when the amount of accumulation exceeds the reference amount. As described herein, performing a reproduction of auxiliary contents when the main contents cannot be reproduced avoids discontinuity of content reproduction proceeded from communication line conditions. This prevents the user from experiencing an unpleasant feeling such as irritation and/or anxiety. Thus the user can pleasantly enjoy the content.

Thus, since the amount of accumulation of main contents is determined as the reference of content switching, it is possible to determine a switching operation without using a complex means and to perform an exact determination of the switching operation.

Thus, since the main contents are returned in place of auxiliary contents as the amount of accumulation reaches a predetermined reference amount, it is possible to sequentially reproduce main contents by the volume of the reference amount. Accordingly, frequent switching is avoided between main contents and auxiliary contents. Thus, an unpleasant feeling of the user can be suppressed that occurs as main contents are switched to auxiliary contents or vice versa.

A content for reproduction is switched to an auxiliary content when the amount of accumulation of the main contents falls short of a predetermined reference amount during a reproduction of the main contents. A content for reproduction is returned to the main content when the amount of accumulation exceeds the reference amount. This enables the auxiliary content to be reproduced when the main content cannot be reproduced. This avoids discontinuity of content reproduction proceeded from communication line conditions. Accordingly, this prevents the user from experiencing an unpleasant feeling, such as irritation and/or anxiety, thus giving the user a pleasant enjoyment of main contents.

Thus, since the amount of accumulation of the main contents is determined as the reference of content switching, it is possible to determine a switching operation without using complex means and to perform an exact determination of switching operation.

Thus, since the main contents are returned in place of auxiliary contents as the amount of accumulation reaches a predetermined reference amount, it is possible to sequentially reproduce main contents by the volume of the reference amount. Accordingly, a frequent switching is avoided between main contents and auxiliary contents. Thus, an unpleasant feeling to the user can be suppressed that occurs as main contents are switched to auxiliary contents or vice versa.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a structural diagram illustrating one example of a content reception and reproduction apparatus according to the present invention;

FIG. 2 is a timing diagram for the content reception and reproduction apparatus;

FIG. 3 is a flowchart illustrating the operation of the content reception and reproduction apparatus according to the present invention; and

FIG. 4 is a structural diagram illustrating another example of a content reception and reproduction apparatus.

### DETAILED DESCRIPTION OF THE PREFERRED EMBODIMENTS

A mode of the present invention will be explained in detail with reference to accompanying drawings.

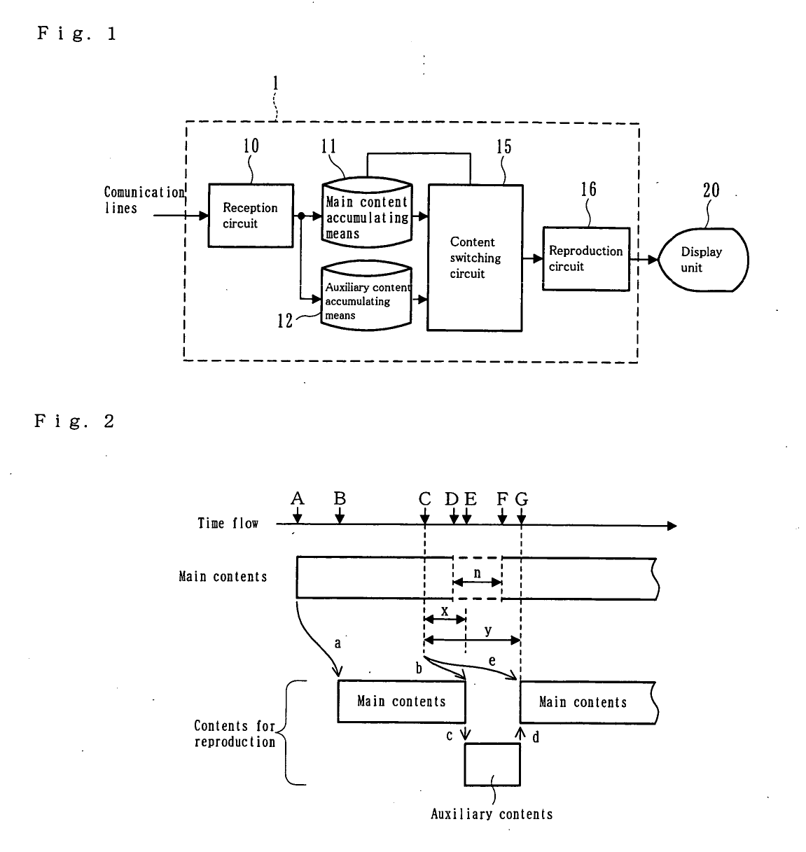

A content reception and reproduction apparatus 1, shown in FIG. 1, includes a reception circuit 10, as a reception mechanism for receiving contents; a main content accumulating mechanism 11 for accumulating contents received by the reception circuit as main contents; an auxiliary content accumulating mechanism 12 for accumulating reproducible contents other than the main contents as auxiliary contents; a content switching circuit 15 for switching from a main content to an auxiliary content and vice versa, a reproduction circuit 16 being a reproduction mechanism for reproducing contents; and a display unit 20 such as a CRT and/or a liquid crystal display for displaying reproduced contents.

The term “content” is defined by a time correlation continual data having a time element (time factor), such as picture and/or voice (including music). Also, a still picture is included in the content by means of sequentially displaying one and/or a plurality of still pictures to provide the still picture with time correlation. Also, the term “main content” is defined by content such as a movie and/or a audiovisual program that the user of the content reception and reproduction apparatus 1 has received through communication lines for enjoyment.

The term “auxiliary content” is defined by a stably reproducible content other than the main content, such as a commercial message, weather information, traffic information, landscape and background music, serving as an auxiliary role for the main content. The auxiliary content accumulating mechanism 12 shown in FIG. 1 is one mode of the auxiliary content acquiring mechanism for acquiring and accumulating auxiliary contents, which will be described with other examples later.

The reception circuit 10 shown in FIG. 1 is a reception mechanism for receiving contents through communication lines such as a telephone line and/or an LAN. The reception circuit 10 includes a communication circuit, such as an analog modem, an ADSL modem, a terminal adaptor and/or an LAN adaptor, and a control and acquisition circuit to acquire contents by means of information interchange with contents supplier, such as a server in which contents are preserved. The main content accumulating mechanism 11 is a storage medium for sequentially accumulating contents sent from the reception circuit 10 as a main content. The main content accumulating mechanism 11 is preferably a medium capable of reading while accumulating contents, which is a random access type storage device such as a hard drive. For medium other than a hard drive, an IC memory, an optical storage medium (such as a CD-R, a CD-RW, a DVD-RAM) and/or others can be employed. And the main content accumulating mechanism 11 is not restricted to one built in the content reception and reproduction apparatus 1, and may be of any type that can freely be installed and removed from the content reception and reproduction apparatus 1.

The auxiliary content accumulating mechanism 12 is a recording medium for accumulating contents sent from the reception circuit 10 as an auxiliary content. As is different from the main content accumulating mechanism 11, it is not necessary to be a recording medium capable of reading while sequentially accumulating contents. The recording medium may be a recording medium such as a video tape or the like. Note that, in the auxiliary content accumulating mechanism 12, auxiliary contents received by the reception circuit 10 shall be preserved in advance.

The content switching circuit 15 is a content switching mechanism for switching either the main content in the main content accumulating mechanism 11 and/or the auxiliary content in the auxiliary content accumulating mechanism 12 to read and reproduce it. The content read by the content switching circuit 15 is reproduced by the reproduction circuit 16 and is displayed on the display unit 20.

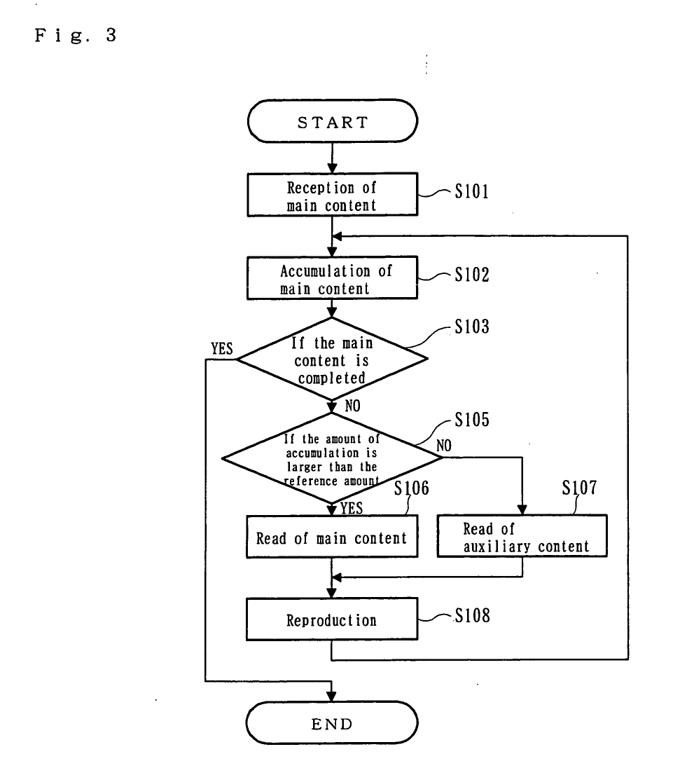

Next, the operation of the content reception and reproduction apparatus 1 according to an embodiment of the present invention will be explained. In the following explanation of a carrying-out mode, reference numerals given in parentheses correspond with those in the flowchart in FIG. 3.

First, the reception circuit 10 receives a main content (S101) through communication lines. The received main content is sequentially accumulated in the main content accumulating mechanism 11 (S102). A state of accumulation of this main content is exhibited by means of a main content bar in a timing explaining diagram in FIG. 2. The accumulation of the main content is started at time A in FIG. 2. Although FIG. 3 illustrates that a verifying operation of a main content completion is performed (S103) immediately after the operation commencement of the content reception and reproduction apparatus 1, with respect to the time immediately after the operation is commenced, it is assumed that accumulated main contents are reproduced (arrow a) by the reproduction circuit 16 from the head of the main contents at the time (time B) as a predetermined amount of the main contents is accumulated. Next, they are displayed by the display unit 20 (this state is exhibited by means of a reproduction content bar in FIG. 2). However, the operation of the content reception and reproduction apparatus 1 is not limited to the operation above. The operation may be practiced according to the flowchart performing a reproduction of the auxiliary contents immediately after the operation commencement, which will be described later.

After the reception and accumulation (S102) of the main contents is favorably performed through communication lines and the reproduction of the main contents is started, verification is performed to verify whether or not the reproduction of the main contents is completed (S103). When main contents to be reproduced still remain (S103-NO), verification is performed to verify whether or not the amount of main contents accumulated in the main content accumulating mechanism 11 is larger than a predetermined reference amount x (S105). This reference amount x (synonymous with the length x of the arrow shown in FIG. 2) is an amount that the reproduction circuit 16 can stably and sequentially reproduce main contents without giving the user an unpleasant feeling. Also, the reference amount x has the same unit as the amount of the data accumulated in the main content accumulating mechanism 11. The byte is used, for example, which is a unit of the volume of accumulated data. In a period from time B to time C, the amount of accumulated main contents is larger than the reference amount x. Thus, the amount of accumulation exceeds the reference amount x in a determination between the amount of accumulated data and the reference amount x (S105-YES), which read main contents from the main content accumulating mechanism 11 (S106) to reproduce them (S108).

Meanwhile, at time E, it is assumed that the amount of main contents accumulated in the main content accumulating mechanism 11 do not reach the reference amount x (S105-NO) due to the discontinuity of content reception and/or the decrease of communication speed from time D (section n) when the amount of main contents is attempted to verify (S105) to reproduce them (arrow b) at time C. When the reproduction of the main contents continues, the main contents in the main content accumulating mechanism 11 become exhausted and nothing is reproduced on the screen of the display unit 20. This causes the user to have an unpleasant feeling. Therefore, the content switching circuit 15 reads auxiliary contents (S107) accumulated in the auxiliary content accumulating mechanism 12 in advance to reproduce the auxiliary contents (S108 and an arrow c in FIG. 2).

After the communication condition is improved at time F, the main contents accumulated in the main content accumulating mechanism 11 is resumed (arrows d and e in FIG. 2) reading (S106) and reproducing (S108) again at a time when an amount y of accumulation of the main contents gradually accumulated in the main content accumulating mechanism 11 exceeds the reference amount x (S105-YES and time G in FIG. 2). When the reproduction of the main contents accumulated in the main content accumulating mechanism 11 is finally completed (S103-YES), an operation of the content reception and reproduction apparatus 1 per se is concluded (END).

As described above, according to the content reception and reproduction apparatus 1 of the present embodiment, the content for reproduction is switched to the auxiliary content when the amount of main contents falls short of the predetermined reference amount during a reproduction of main contents. The content for reproduction is returned to the main content when the amount of accumulation exceeds the reference amount. This allows auxiliary contents to be reproduced when main contents cannot be reproduced. This avoids discontinuity of content reproduction that is proceeded from communication line conditions. This prevents the user from experiencing an unpleasant feeling, such as irritation and/or anxiety, thus giving the user a pleasant enjoyment of the main contents.

Thus, since the amount of accumulation of main contents is determined as the reference of content switching, it is possible to determine a switching operation without using complex means and to perform an exact determination of the switching operation.

Thus, since the main contents are returned in place of the auxiliary contents as the amount of accumulation reaches a predetermined reference amount, it is possible to sequentially reproduce main contents by the volume of the reference amount. Accordingly, frequent switching is avoided between the main contents and auxiliary contents. Thus, an unpleasant feeling to the user can be suppressed as the main contents are switched to auxiliary contents and vice versa.

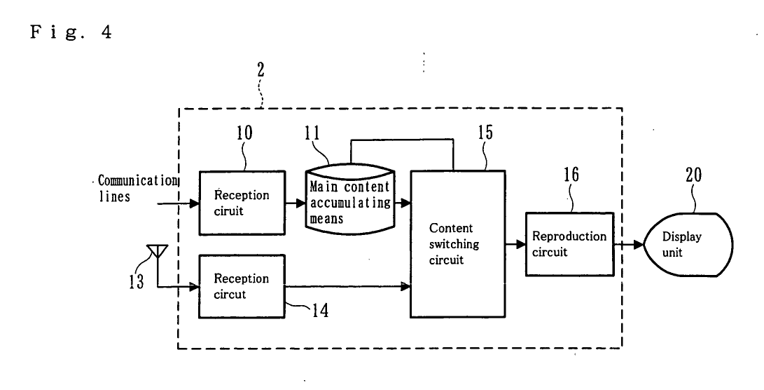

Although the main content accumulating mechanism 11 and the auxiliary content accumulating mechanism 12 are described as separate storage mediums, it is possible to form them as one recording medium. Also, although an auxiliary content acquiring mechanism is structured by the reception circuit 10 and the auxiliary content accumulating mechanism 12, the auxiliary content acquiring mechanism is not limited to such a structure. Thus, it may be of any mechanism capable of acquiring auxiliary contents that are stably reproducible for a period when main contents cannot be reproduced. Turning to FIG. 4, another example of an auxiliary content acquiring mechanism is shown.

An auxiliary content acquiring mechanism in a content reception and reproduction apparatus 2 shown in FIG. 4 includes an antenna 13 and a reception circuit 14 to receive TV ground wave and satellite broadcasting. The TV ground wave and satellite broadcasting can hardly generate a trouble in reception basically, so that it is possible to stably acquire and reproduce contents received as auxiliary contents. As described above, the term “reproduction” used in this specification includes not only the display of accumulated contents but also a real time display of contents received by the reception circuit 14 without accumulating them.

Note that, a mechanism for realizing the content reception and reproduction apparatus 1 and/or 2 may be a specified device that is realized by hardware and/or software. The functions of this embodiment may be incorporated into a conventional video apparatus, and realized by operating a computer as the content reception and reproduction apparatus.

The amount of accumulation and the reference amount of main contents accumulated in the main content accumulating means 11 are not restrained by the accumulated volume (unit of byte, for example) of data, and may be one for expressing the amount of main contents that are reproducible. The amount of accumulation can also be grasped as a period of time when contents can be reproduced. In this case, main contents are switched to auxiliary contents in accordance with a period in which reproducible data is accumulated as main contents. Since the amount of accumulation is grasped as a period of time when contents can be reproduced, it is possible to grasp the amount of accumulation regardless of compression form or communication form even when the main contents data received through a communication line are compressed. Thus, it is possible to switch between the main contents and the auxiliary contents without giving the user an unpleasant feeling.

In a conventional content reception and reproduction apparatus, when time information for reproduction of data is included in the received main contents data, even if a communication line is in a favorable congestion level and it is possible to receive data without delay, a reproduction time period does not coincide with an actual reproduction time period as the received main contents data is reproduced according to a reception speed, which comes to an unnatural reproduction in the content reception and reproduction apparatus 1 according to this embodiment, even in the conditions above, since the amount of accumulation is grasped as a volume of reproducible contents, a reproduction time period cannot lead an unnatural reproduction resulted from not being coincident with an actual reproduction time period due to communication line conditions. Thus, it is possible to perform a reproduction suitable for the conditions of accumulated main contents. Thus, not providing the user with an unpleasant feeling.

### APPLICABILITY IN INDUSTRIES

As explained hereinbefore, the present invention is not restricted to this embodiment described above. A content reception and reproduction apparatus for application may have other structures, for example.

Also, when the amount of accumulation of the main contents accumulated in a main content accumulating mechanism is sufficient to ensure a reproduction time that prevents the user from experiencing an unpleasant feeling, there is no need to receive main contents. A communication line and a reception circuit can be utilized for purposes other than the reception of the main contents. In a content reception and reproduction apparatus according to the present carrying-out mode, for example, auxiliary contents for accumulation by an auxiliary content accumulating mechanism can be received and accumulated through a communication line and a reception circuit. As described herein, it is also possible to efficiently utilize communication lines according to the conditions of the communication lines.

The present invention has been described with reference to the preferred embodiment. Obviously, modifications and alternations will occur to those of ordinary skill in the art upon reading and understanding the preceding detailed description. It is intended that the present invention be construed as including all such alternations and modifications insofar as they come within the scope of the appended claims or the equivalents thereof.

1-2. (canceled)

3. A content reception and reproduction apparatus comprising:
a reception mechanism for receiving a content through a communication mechanism;
an accumulation mechanism for accumulating said content received by said reception mechanism as a main content;
a reproduction mechanism for reproducing said main content;
an auxiliary content acquiring mechanism for acquiring a reproducible content other than said main content as an auxiliary content;
a content switching mechanism for switching a content reproduced by said reproduction means to any one of said main content and said auxiliary content, wherein a content for reproduction is switched to said auxiliary content when the amount of accumulation of said main contents falls short of a predetermined reference amount during a reproduction of said main contents, and a content for reproduction is returned to said main content when said amount of accumulation exceeds said reference amount.

4. A content reception and reproduction method where a content is received through a reception mechanism, said content is accumulated in an accumulation mechanism as a main content and then said main content is reproduced, comprising the steps of:
producing an auxiliary content after the reproduction of said main content is commenced in a state where a reproducible content other than said main content can be acquired; switching a content for reproduction to said auxiliary content when the amount of accumulation of said main contents falls short of a predetermined reference amount during a reproduction of said main contents; and returning a content for reproduction to said main content when said amount of accumulation exceeds said reference amount.
